(19) United States
(12) Patent Application Publication
(10) Pub. No.: US 2015/0138833 A1
(43) Pub. Date: May 21, 2015

(54) BACKLIGHT MODULE AND LIQUID CYRSTAL DISPLAY DEVICE INCLUDING THE SAME

(71) Applicant: SHENZHEN CHINA STAR OPTOELECTRONICS TECHNOLOGY CO., LTD, Shenzhen (CN)

(72) Inventor: Hu He, Shenzhen (CN)

(21) Appl. No.: 14/240,334

(22) PCT Filed: Jan. 21, 2014
(86) PCT No.: PCT/CN2014/071009

§ 371 Date: Feb. 21, 2014

(30) Foreign Application Priority Data
Sep. 9, 2013 (CN) 201310408424.7

(51) Int. Cl. F21V 8/00; G02F 1/1335

(52) U.S. Cl. CPC G02B 6/0038; G02B 6/0073; G02F 1/1336
USPC 362/611; 362/619; 362/620

(57) ABSTRACT

The present disclosure relates to a backlight module and a liquid crystal display device including the backlight module. The backlight module includes a light guide plate and a planar reflecting sheet arranged below the light guide plate, wherein a plurality of lattice points are provided on the upper surface of the light guide plate so that the upper surface forms a light-emitting surface, and a plurality of cylindrical projections in contact with the planar reflecting sheet are formed on the lower surface of the light guide plate. With this backlight module, the probability of the lattice points being scratched can be significantly reduced, and the quality of the final product can be improved.

### FIELD OF THE INVENTION

The present disclosure relates to a liquid crystal device, in particular to a backlight module. The present disclosure also relates to a liquid crystal display device using the backlight module.

### BACKGROUND OF THE INVENTION

In a liquid crystal display, a light guide plate is needed to propagate light from a light source so as to illuminate display areas of the liquid crystal display. The working principle of the light guide plate is as follows. The light emitted by the light source (such as a light emitting diode, namely LED) is coupled to the light guide plate and then propagated. When the light does not meet lattice points provided on the light guide plate, the light will only be subjected to total internal reflection in the light guide plate and propagated to a distant position; and when the light meets the lattice points, the total internal reflection of the light will be destroyed under the influence of the lattice points, so that the light will be scattered or reflected and finally guided out from a light-emitting surface of the light guide plate. The portion of the light emitted at different positions of the light guide plate can be adjusted by changing the distribution of the lattice points, so that a uniform backlight module can be finally realized. Herein, the term “lattice point” refers to a structure arranged at the surface of the light guide plate and enabling the light to be scattered, and is known by those skilled in the art.

In the prior art, the light guide plate is arranged so that the lattice points directly contact with a reflecting sheet. During the assembly of the backlight module, some tiny foreign matters may be left between the light guide plate and the reflecting sheet. Therefore, in the movement or transportation of the backlight module, the light guide plate may be scratched by these foreign matters, which will reduce the quality of a final product.

### SUMMARY OF THE INVENTION

Aiming at the above-mentioned technical problems in the prior art, the present disclosure proposes a backlight module, which can significantly reduce the probability that a light guide plate is scratched and thus improve the quality of a final product. Moreover, the present disclosure also relates to a liquid crystal display device using the backlight module.

1) According to the first aspect of the present disclosure, a backlight module is provided, including a light guide plate and a planar reflecting sheet arranged below the light guide plate, wherein a plurality of lattice points are provided on the upper surface of the light guide plate so that the upper surface forms a light-emitting surface, and a plurality of cylindrical projections in contact with the planar reflecting sheet are formed on the lower surface of the light guide plate.

According to the backlight module of the present disclosure, a plurality of gaps is formed between the light guide plate and the reflecting sheet due to existence of the cylindrical projections. Therefore, foreign matters between the light guide plate and the reflecting sheet can be accommodated in these gaps so as not to scratch the light guide plate. In addition, the lattice points are no longer adjacent to the reflecting sheet, so that the problem that the lattice points may be scratched can be thoroughly solved. In this way, the quality of the final product can be improved.

2) In an implementation mode of 1) according to the present disclosure, the height differences between respective cylindrical projections and the lower surface of the light guide plate are the same. In an embodiment, the distances between adjacent cylindrical projections are also the same. In a preferred embodiment, the height differences can be in a range from 0.05 to 350 mm, and the distances can be in a range from 0.01 to 0.15 mm. Through the projections with such a structure, the gaps formed between the light guide plate and the reflecting sheet can generally accommodate most of foreign matters therein, so that the light guide plate is prevented from being scratched. In a specific embodiment, the cylindrical projections are prismatic or cylindrical. The cylindrical projections with such a structure are easy to manufacture, so that the production difficulty of the light guide plate is reduced.

3) In an implementation mode of 1) or 2) according to the present disclosure, the lattice points protrude from the upper surface of the light guide plate, or are depressed inside the upper surface of the light guide plate. In a specific embodiment, the lattice points are shaped as one of hemispherical projections or depressions, parallelepiped projections or depressions. At least one of size, distance, height or depth and reflectivity of a part of the plurality of lattice points is selected as being different from that of the other lattice points. The lattice points with such configuration can likewise destroy the total internal reflection of light in the light guide plate, and thus the light can be uniformly emitted from the light-emitting surface of the light guide plate through distribution of the lattice points. In an embodiment, the lattice points are formed through one of ink printing, roller forming, injection molding, laser engraving and ink-jet printing.

4) In an implementation mode of any of 1) to 3) according to the present disclosure, the cylindrical projections are arranged in parallel along a first direction and extend along a second direction. The backlight module further includes a light source adjacent to the side of the light guide plate, so that the light can enter the light guide plate from the side of the light guide plate and then is propagated along the second direction. In an embodiment, the first direction is vertical to the second direction.

5) According to the second aspect of the present disclosure, a liquid crystal display device is proposed, which includes the above-mentioned backlight module.

It should be noted that in the context, directional terms, such as upper and lower, are mentioned with reference to the directions shown in the accompanying drawings. Therefore, these directional terms are used for illustrating rather than limiting the protection scope of the present disclosure.

Compared with the prior art, the present disclosure has the following advantages. With the plurality of cylindrical projections formed on the surface of the light guide plate in contact with the reflecting sheet and gaps formed between these cylindrical projections, the foreign matters between the light guide plate and the reflecting sheet can be accommodated in the gaps, and thus will not scratch the light guide plate. In addition, the lattice points are not adjacent to the reflecting sheet, so that the problem that the lattice points may be scratched is thoroughly solved. Consequently, the quality of the final product can be improved.

### BRIEF DESCRIPTION OF THE DRAWINGS

The present disclosure will be described in more detail below based on the embodiments with reference to the accompanying drawings. In the drawings:

FIG. 1 is a schematic diagram of a backlight module according to the present disclosure;

FIG. 2 is a three-dimensional schematic diagram of cylindrical projections on the lower surface of a light guide plate according to the present disclosure; and

FIG. 3 to FIG. 5 show schematic diagrams of lattice points of the light guide plate of the present disclosure.

In the accompanying drawings, the same components are indicated by the same reference signs. The accompanying drawings are not drawn in actual scales.

### DETAILED DESCRIPTION OF THE EMBODIMENTS

The present disclosure will be further illustrated below in conjunction with the accompanying drawings.

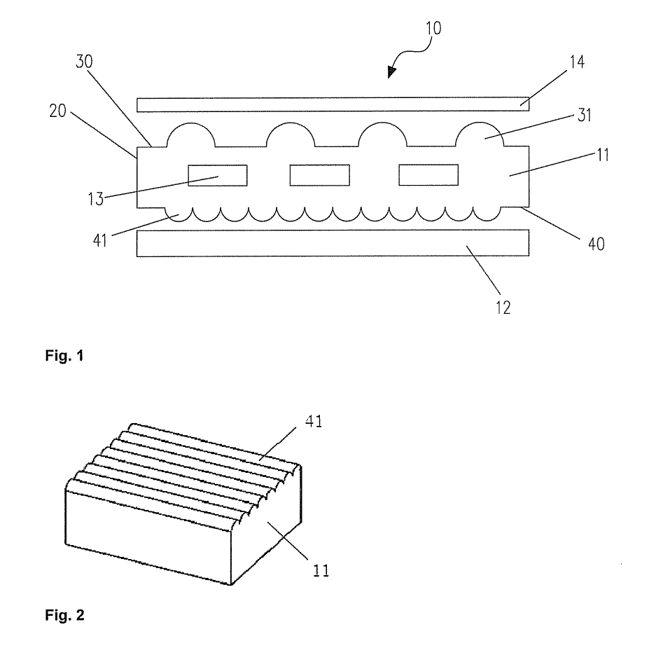

FIG. 1 schematically shows a structure of a backlight module 10 according to the present disclosure. The backlight module 10 includes a light guide plate 11 and a reflecting sheet 12 arranged below the light guide plate 11. The reflecting sheet 12 can be a generally planar sheet. The backlight module 10 further includes a light source 13 and a group of optical diaphragms 14. The light source 13 is arranged at a light-incoming side of the light guide plate 11 for providing light beams. The light guide plate 11 is configured to guide the beams provided by the light sources 12 to be propagated to a distant place, and the beams are emitted from a light-emitting surface of the light guide plate 11 at appropriate positions, so as to illuminate display areas of a display device.

As shown in FIG. 1, the light guide plate 11 has a light-incoming side 20, a light-emitting surface 30 and a lower surface 40. The light-incoming side 20 is adjacent to the light source 13. A plurality of lattice points 31 are provided on the upper surface of the light guide plate 11. These lattice points 31 can refract the beams entering the light guide plate 11 from the light-incoming side 20, so that the beams are scattered and emitted from the upper surface of the light guide plate 11, which forms a light-emitting surface 30 accordingly. The lattice points 31 will be described in detail below. The group of optical diaphragms 14 is arranged on the outer side adjacent to the light-emitting surface 30, and may include a diffuser, a brightening sheet and the like, for example. The light-emitting surface 30 and the lower surface 40 are arranged oppositely. The reflecting sheet 12 is arranged below the lower surface 40.

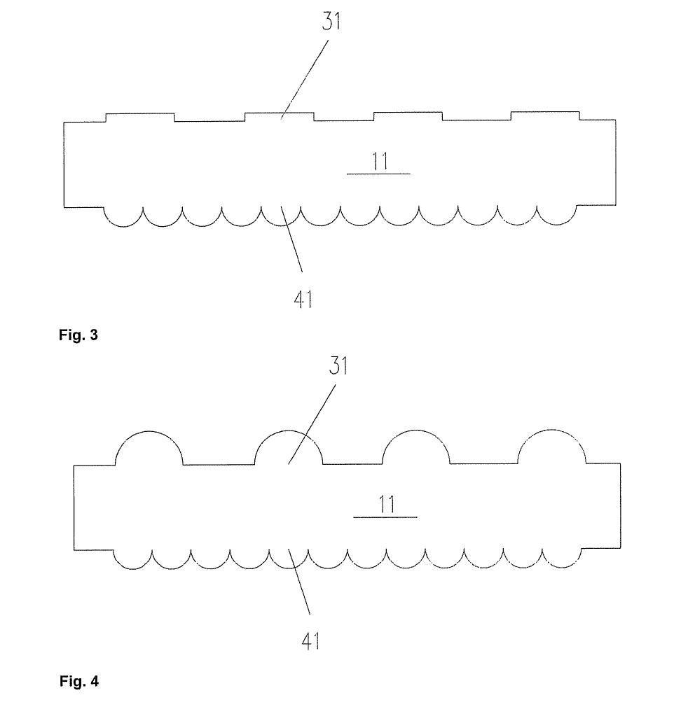

As shown in FIG. 1 and FIG. 2, a plurality of cylindrical projections 41 are formed on the lower surface 40 of the light guide plate 11. These cylindrical projections 41 are arranged in parallel along a first direction, extend along a second direction and contact the reflecting sheet 12. It should be noted that FIG. 1 merely schematically shows the position of the reflecting sheet 12 rather than the actual assembly status. The second direction is a direction that light is emitted from the light source 13 to enter the light guide plate 11 and propagated along the light guide plate 11, whereas the first direction is vertical to the second direction. In an embodiment, the light source 13 includes multiple light emitting diode (namely LED) modules arranged uniformly along the first direction, as shown in FIG. 1.

With the plurality of cylindrical projections 41 provided on the lower surface 40 of the light guide plate 11, a plurality of gaps will be formed between the light guide plate 11 and the reflecting sheet 12 accordingly. Due to existence of theses gaps, foreign matters between the light guide plate 11 and the reflecting sheet 12 can be accommodated within the gaps, so as not to scratch the light guide plate 11. In a specific embodiment, the distances that the cylindrical projections 41 protrude from the lower surface 40 of the light guide plate 11 are set between 0.05 and 350 mm, and the distances between adjacent cylindrical projections 41 are between 0.01 and 0.15 mm. Through the projections with such sizes, the gaps between the light guide plate 11 and the reflecting sheet 12 can generally accommodate most of foreign matters, so that the light guide plate 11 will be prevented from being scratched. In addition, the lattice points 31 are not directly adjacent to the reflecting sheet 12, so that the problem that the lattice points 31 may be scratched can be completely solved, thus further improving the quality of the final product. In a specific embodiment, the cylindrical projections 41 may be prismatic or cylindrical. The cylindrical projections with such a structure are easy to manufacture, so that the production difficulty of the light guide plate 11 is reduced. In addition, in order to facilitate the assembly of the light guide plate 11 and the reflecting sheet 12, the distances that the cylindrical projections 41 protrude from the lower surface 40 of the light guide plate 11 are set to be the same. The distances between the adjacent cylindrical projections 41 are also the same.

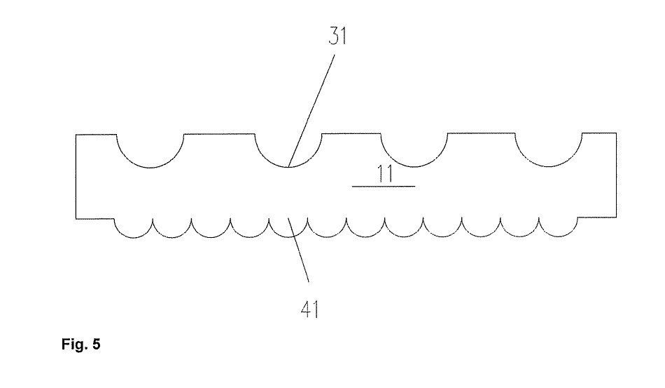

FIG. 3 to FIG. 5 schematically show the lattice points 31 arranged on the upper surface of the light guide plate 11. These lattice points 31 can be configured as protruding from the upper surface of the light guide plate 11 (as shown in FIG. 3 and FIG. 4), or being depressed inside the upper surface of the light guide plate 11 (as shown in FIG. 5). In addition, these lattice points 31 can be shaped as hemispherical projections or depressions (as shown in FIG. 4 and FIG. 5), or parallelepiped, such as rectangular, projections or depressions (as shown in FIG. 3). To ensure uniform scattering of the light in the light guide plate 11, at least one of size, distance, height or depth and reflectivity of a part of these lattice points 31 can be set to be different from that of the other lattice points. For example, the lattice points may be designed with equal size but different distances, equal distance but different sizes, or equal distance and size but different heights or depths and reflectivities, or the like. Those skilled in the art may freely combine these technical features for use according to actual needs. The lattice points 31 may be provided on the upper surface of the light guide plate 11 through ink printing, roller forming, injection molding, laser engraving or ink-jet printing, so as to scatter the light in the light guide plate 11.

The present disclosure further relates to a liquid crystal display device using the backlight module 10, such as a liquid crystal display screen. Because the backlight module 10 can prevent the light guide plate 11 from being scratched, the quality of the liquid crystal display device can be also improved.

Although the present disclosure has been described with reference to the preferred embodiments, various modifications could be made to the present disclosure without departing from the scope of the present disclosure and components in the present disclosure could be substituted by equivalents. Particularly, as long as structural conflicts do not exist, all technical features mentioned in all the embodiments may be combined together in any mode. The present disclosure is not limited to the specific embodiments disclosed in the description, but includes all technical solutions falling into the scope of the claims.

1. A backlight module, including a light guide plate and a planar reflecting sheet arranged below the light guide plate, wherein a plurality of lattice points are provided on the upper surface of the light guide plate so that the upper surface forms a light-emitting surface, and a plurality of cylindrical projections in contact with the planar reflecting sheet are formed on the lower surface of the light guide plate.

2. The backlight module according to claim 1, wherein the height differences between respective cylindrical projections and the lower surface of the light guide plate are the same.

3. The backlight module according to claim 2, wherein the distances between adjacent cylindrical projections are the same.

4. The backlight module according to claim 3, wherein the height differences can be in a range from 0.05 to 350 mm, and the distances can be in a range from 0.01 to 0.15 mm.

5. The backlight module according to claim 3, wherein the cylindrical projections are prismatic or cylindrical.

6. The backlight module according to claim 5, wherein the cylindrical projections are arranged in parallel along a first direction and extend along a second direction.

7. The backlight module according to claim 6, wherein the backlight module further includes a light source adjacent to the side of the light guide plate, so that the light can enter the light guide plate from the side of the light guide plate and then is propagated along the second direction.

8. The backlight module according to claim 7, wherein the first direction is vertical to the second direction.

9. The backlight module according to claim 3, wherein the lattice points protrude from the upper surface of the light guide plate, or are depressed inside the upper surface of the light guide plate.

10. The backlight module according to claim 9, wherein the lattice points are shaped as one of hemispherical projections or depressions, parallelepiped projections or depressions.

11. The backlight module according to claim 10, wherein at least one of size, distance, height or depth and reflectivity of a part of the plurality of lattice points is selected as being different from that of the other lattice points.

12. The backlight module according to claim 11, wherein the lattice points are formed through one of ink printing, roller forming, injection molding, laser engraving and ink-jet printing.

13. A liquid crystal display device including the backlight module according to claim 1.

14. A liquid crystal display device including the backlight module according to claim 8.
